(19) United States
(12) Patent Application Publication
(10) Pub. No.: US 2016/0359979 A1
(43) Pub. Date: Dec. 8, 2016

(54) COMMUNICATION DEVICE, COMMUNICATION SYSTEM, AND COMPUTER PROGRAM PRODUCT

(71) Applicant: Kabushiki Kaisha Toshiba, Minato-ku (JP)

(72) Inventors: Masashi ITO, Yokohama (JP); Akira Kawarada, Fuchu (JP)

(73) Assignee: Kabushiki Kaisha Toshiba, Minato-ku (JP)

(21) Appl. No.: 14/946,922

(22) Filed: Nov. 20, 2015

(30) Foreign Application Priority Data
Jun. 5, 2015 (JP) 2015-115071

(51) Int. Cl. H04L 29/08

(52) U.S. Cl. CPC H04L 67/125; H04L 67/1095

(57) ABSTRACT

According to an embodiment, a communication device includes an application, a transmitter, a communication unit, and an estimator. The application is configured to generate application data in each first cycle. The transmitter configured to transmit the application data to a network at a random timing within the first cycle in each first cycle. The communication unit is configured to communicate with another communication device via the network in each second cycle. The estimator is configured to calculate an outward communication time and a return communication time communication between the communication device and the other communication device in each second cycle, and estimate a communication delay time between the communication device and the other communication device based on the calculated outward communication times and the calculated return communication times.

### CROSS-REFERENCE TO RELATED APPLICATION

This application is based upon and claims the benefit of priority from Japanese Patent Application No. 2015-115071, filed on Jun. 5, 2015; the entire contents of which are incorporated herein by reference.

### FIELD

Embodiments described herein relate generally to a communication device, a communication system, and a computer program product.

### BACKGROUND

In the related art, a technique is known whereby, prior to communication of first-type data, communication of data other than the first-type data is prohibited in order to avoid conflict between communication of the first-type data and communication of data other than the first-type data within a network.

In the related art as described above, however, communication of data other than the first-type data is prohibited and thus cyclic communication is not ensured when the data, of which communication is prohibited, requires cyclic communication.

### BRIEF DESCRIPTION OF THE DRAWINGS

FIG. 1 is a diagram illustrating an exemplary configuration of a communication system according to a first embodiment;

FIG. 2 is a diagram illustrating an exemplary configuration of a slave device according to the first embodiment;

FIG. 3 is a diagram illustrating an exemplary configuration of a master device according to the first embodiment;

FIG. 4 is a flowchart illustrating exemplary processing for generating application data according to the first embodiment;

FIG. 5 is a flowchart illustrating exemplary processing for transmitting application data according to the first embodiment;

FIG. 6 is a sequence diagram illustrating exemplary synchronization processing according to the first. embodiment;

FIG. 7 is a diagram illustrating an exemplary configuration of a communication system according to a second embodiment;

FIG. 8 is a diagram illustrating an exemplary configuration of a communication device according to the second embodiment;

FIG. 9 is a diagram illustrating an exemplary configuration of a communication system according to a third embodiment;

FIG. 10 is a diagram illustrating an exemplary configuration of a communication device according to the third embodiment;

FIG. 11 is a diagram illustrating an exemplary configuration of a transfer device according to the third embodiment;

FIG. 12 is a flowchart illustrating exemplary processing in the communication device according to the third embodiment;

FIG. 13 a flowchart illustrating exemplary processing in the transfer device according to the third embodiment; and

FIG. 14 is a diagram illustrating an exemplary configuration of hardware of the respective devices according to the respective embodiments.

### DETAILED DESCRIPTION

According to an embodiment, a communication device includes an application, a transmitter, a communication unit, and an estimator. The application is configured to generate application data in each first cycle. The transmitter configured to transmit the application data to a network at a random timing within the first cycle in each first cycle. The communication unit is configured to communicate with another communication device via the network in each second cycle. The estimator is configured to calculate an outward communication time and a return communication time of communication between the communication device and the other communication device in each second cycle, and estimate a communication delay time between the communication device and the other communication device based on the calculated outward communication times and the calculated return communication times.

Embodiments will be described below in detail with reference to the accompanying drawings.

### First Embodiment

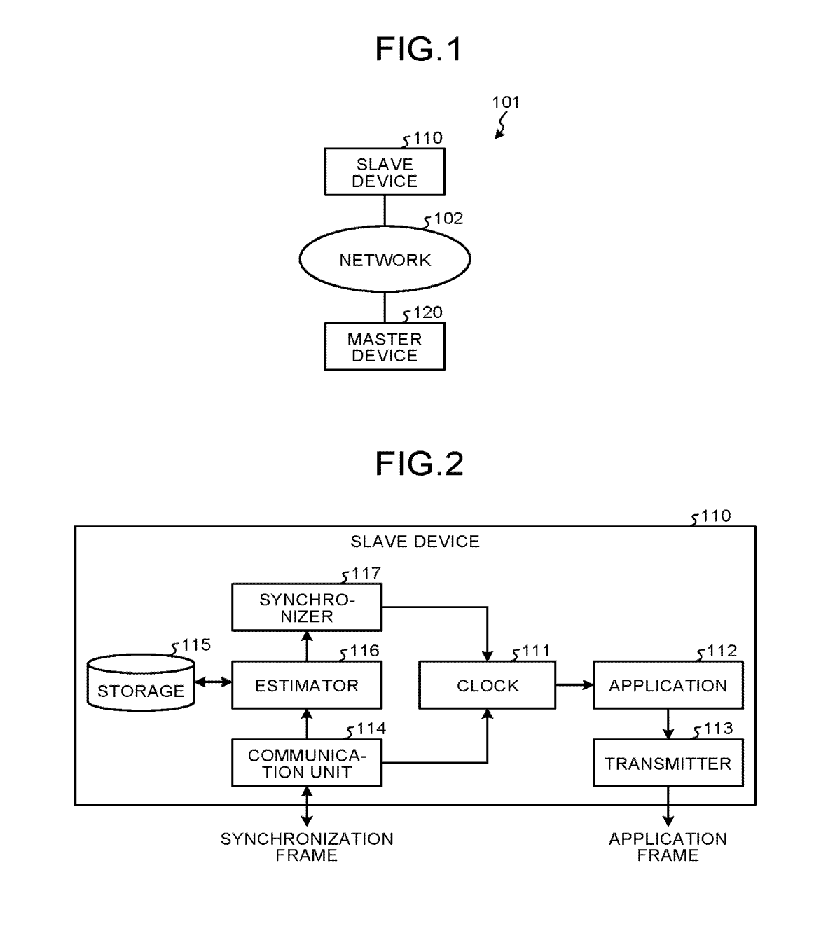

FIG. 1 is a diagram illustrating an exemplary configuration of a communication system 101 according to first embodiment. As illustrated in FIG. 1, the communication system 101 includes a slave device 110 (an example of a communication device and a first communication device) and a master device n example of another communication device and a second communication device).

The slave device 110 and the master device 120 are connected to each other via a network 102. The network 102 may be implemented by one or more network devices that relay communication such as a switch device.

The master device 120 times reference time for time synchronization and is a computer that is a time synchronization source such as a server. The slave device 110 communicates (transmits and receives) synchronization data for time synchronization with the master device 120 via the network 102, obtains the reference time timed by the master device 120, and synchronizes its own local time using the obtained reference time. The slave device 110 may be, for example, an industrial apparatus but not limited thereto.

Note that the communication system 101 may include a communication device connected to the network 102 other than the slave device 110 and the master device 120.

FIG. 2 is a diagram illustrating an exemplary configuration of the slave device 110 according to the first embodiment. As illustrated in FIG. 2, the slave device 110 includes a clock 111, an application 112 (an example of a first application), a transmitter 113 (an example of a first transmitter), a communication unit 114 (an example of a first communication unit), a storage 115, an estimator 116, and a synchronizer 117.

The clock 111, application 112, transmitter 113, communication unit 114, storage 115, estimator 116, and synchronizer 117 may be implemented by execution of a program by a processor such as a central processing unit (CPU), namely, by software, by hardware such as an integrated circuit (IC), or by combination of software and hardware. The storage 115 may be implemented by a magnetically, optically, or electrically recordable storage such as a hard disk drive (HDD), solid state drive (SSD), memory card, optical disk, random access memory (RAM), and read only memory (ROM).

The clock 111 times local time which is time within the lave device 110. Here, the clock 111 also functions, while using the local time that the clock 111 times, cycle timer for timing a first cycle, a random timer for timing random time within the first cycle, and a second cycle timer for timing a second cycle.

The first cycle is a transmission cycle of application data generated by the application 112 (an example of first application data). The second cycle is a synchronization cycle for time synchronization performed by the slave device 110 with the master device 120. The first cycle and the second cycle may be different cycles or the same cycle.

The random time is time shorter than the first cycle and is determined, for example, by the clock 111 with a random value or the like. Therefore, it is expected that the random time different for each of the first cycles. The random timer starts timing the random time when the first cycle timer times the first cycle and times the random time within the first cycle.

The application 112 generates application data each time the first cycle timer times the first cycle.

The first embodiment is described with an example where the application 112 is an application that measures quantity of electricity; however, the application 112 is not limited thereto. In this case, the application 112 measures quantity of electricity in each first cycle, adds (stamps) a time stamp to (an example of a second time stamp) showing the local time timed by the clock 111 (which is the local time when the first cycle is timed as well as the local time when the application data is generated) to the measured quantity of electricity, thereby generating the application data.

The transmitter 113 transmits, in each first cycle, the application data generated by the application 112 to the network 102 at a random timing within the first cycle. Specifically, the transmitter 113 transmits, when the random timer times the random time, an application frame of the application data generated by the application 112 to the network 102.

The communication unit 114 communicates with the mast device 120 via the network 102 every time the second cycle timer times the second cycle. Specifically, the communication unit 114 communicates a synchronization frame of synchronization data for time synchronization to the master device 120 via the network 102 in each second cycle.

For example, the communication unit 114 transmits, in each second cycle, a first synchronization frame including a time stamp t1 showing the local time timed by the clock 111 (which is the local time when the second cycle is timed) to the master device 120 via the network 102.

Thereafter, the communication unit 114 receives a second synchronization frame from the master device 120 via the network 102 and defines, as a time stamp t4, a time stamp showing the local time timed by the clock 111 upon reception of the second synchronization frame.

The second synchronization frame includes a time stamp t2 showing the reference time when the master device 120 has received the first synchronization frame and a time stamp t3 (an example of a first time stamp) showing the reference time when the master device 120 has transmitted the second synchronization frame. Note that the reference time is time timed by the master device 120.

The estimator 116 calculates, in each second cycle, an outward communication time and a return communication time of communication between the slave device 110 and the master device 120 and estimates communication delay time between the slave device 110 and the master device 120 based on the plurality of outward communication times and the plurality of return communication times having been calculated.

Here, the communication delay time is a delay from the reference time due to transmission of the reference time from the master device 110 to the slave device 110 when the slave device 110 synchronizes its local time with the reference time timed by the master device 120. The communication delay time corresponds to, for example, the return communication time from transmission of the second synchronization frame by the master device 120 to reception thereof by the slave device 110.

However, the communication delay time cannot be directly measured since an error in the local time from the reference time is unknown where the time when the master device 120 transmits the second synchronization frame is timed by the reference time in the master device 120 while the time when the slave device 110 receives the second synchronization frame is timed by the local time in the slave device 110.

In the first embodiment, therefore, an estimation method is employed where a round-trip communication time divided by two is estimated as the communication delay time. The round-trip communication time is the sum of the outward communication time from transmission of the first synchronization frame by the slave device 110 to reception thereof by the master device 120 and the return communication time from transmission of the second synchronization frame by the master device 120 to reception thereof by the slave device 110.

In this manner, adding the outward communication time and the return communication time results in compensation of the errors in the local time from the reference time, thereby allowing for estimation of the communication delay time free from influence of the errors in the local time from the reference time.

However, when the communication delay time is estimated in this manner, the communication delay time cannot be correctly estimated unless the outward communication time and the return communication time matches.

In the network 10 (specifically, one or more network devices) that relays the synchronization frame, however, a conflict between the synchronization frame and a communication frame other than the synchronization frame such as the application frame results in fluctuation of queuing time of the synchronization frame. As a result, the outward communication time and the return communication time of the synchronization frame may not match.

This means that, when the outward communication time and the return communication time are shorter, the queuing time has less fluctuation and a difference between the outward communication time and the return communication time is smaller. In order to correctly estimate the communication delay time, therefore, it is preferable to use the short outward communication time and the short return communication time.

In the first embodiment, therefore, the estimator 116 extracts the smallest outward communication time and the smallest return communication time from among the plurality of outward communication times and the plurality of return communication times and estimates, as the communication delay time, the round-trip communication time, which is the sum of the smallest outward communication time and the smallest return communication time having been extracted, divided by two.

Estimation of the communication delay time will be described below in detail.

First, the estimator 116 obtains a set of the time stamps t1 to t4 from the communication unit 114. Also, the storage 115 stores a plurality of sets of time stamps t1 to t4 having previously been obtained from the communication unit 114 by the estimator 116. The estimator 116 obtains the plurality of sets of time stamps t1 to t4 from the storage 115.

that the plurality of sets of time stamps t1 to t4 to obtain from the storage 115 may be previous M sets of time stamps t1 to t4 (where M is a natural number) or all of the sets of time stamps t1 to t4 stored in the storage 115.

Here, when the number of sets of time stamps t1 to t4 obtained from the communication unit 114 and the storage 115 is defined as N (where N is an integer of 2 or more), the estimator 116 estimates the communication delay time with Formula (1).

Communication delay time={min(t4ᵢ−t3ᵢ)+min(t2ⱼ−t1ⱼ)}/2 (1)

The values i and j are variables of natural numbers 1 to N. The term min (t4ᵢ−t3ᵢ) is a function giving the smallest return communication time and the term min (t2ⱼ−t1ⱼ) is a function giving the smallest outward communication time.

Note that the estimator 116 causes the storage 115 to re the set of time stamps t1 to t4 having been obtained from the communication unit 114 after estimating the communication delay time.

The synchronizer 117 performs time synchronization based on the communication delay time estimated by the estimator 116 and the time stamp t3 included in the second synchronization frame having the smallest return communication time.

Specifically, the synchronizer 117 calculates an offset (time difference) between the reference time timed by the master device 120 and the local time timed by the clock 111 using the communication delay time estimated by the estimator 116, the time stamp t3 included in the second synchronization frame having the smallest return communication time, and the time stamp t4 when the second synchronization frame is received, and then causes the clock 111 to correct, with the calculated offset, the local time to be timed.

For example, the synchronizer 117 calculates the offset with Formula (2) and causes the clock 111 to set the calculated offset therein, thereby correcting the local time to be timed. As a result, the local time timed by the clock 111 shifts by the amount of the offset and thus is synchronized with the reference time timed by the master device 120.

Offset=t4_{argmin(t4i-t3i)}−{t3_{argmin(t4i-t3i)}+communication delay time} (2)

The expression argmin(t4ᵢ−t3ᵢ) is a function giving the variable i where the value t4ᵢ−t3ᵢ is the smallest. That is, Formula (2) calculates the offset between the reference time timed by the master device 120 and the local time timed by the clock 111 using the communication delay time estimated by the estimator 116 and the time stamps t3 and t4 where the return communication time is the smallest.

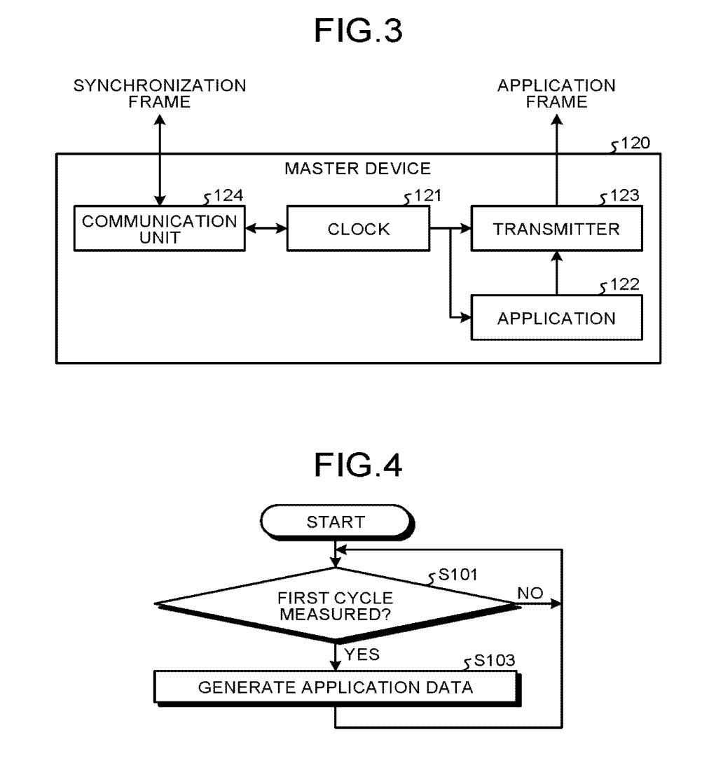

FIG. 3 is a diagram illustrating an exemplary configuration of the master device according to the first embodiment. As illustrated in FIG. 3, the master device 120 include a clock 121, an application 122 (an example of a second application), a transmitter 123 example a second transmitter), and a communication unit 124 (an example of a second communication unit).

The clock 121, application 122, transmitter 123, and communication unit 124 may be implemented by execution of a program by a processor such as a CPU, namely, by software, by hardware such as an IC, or by combination of software and hardware.

The clock 121 times reference time which is time within the master device 120. Here, the clock 121 also functions, while using the reference time that the clock 121 times, as a third cycle timer for timing a third cycle and a random timer for timing random time within the third cycle.

The third cycle is a transmission cycle of application data an example of second application data) generated by the application 122. In the first embodiment, the third cycle is defined as the same cycle as the first cycle but may be a different cycle.

The random time is time shorter than the third cycle and is determined, for example, by the clock 121 with a random value or the like. Therefore, it is expected that the random time is different in each third cycle. The random timer tarts timing the random time when the third cycle timer times the third cycle and times the random time within the third cycle.

The application 122 generates application data each time the third cycle timer times the third cycle.

The first embodiment is described with an example where the application 122 is an application that measures quantity of electricity; however, the application 122 is not limited thereto. In this case, the application 122 measures quantity of electricity in each third cycle, adds (stamps) a time tamp tβ showing the reference time timed by the clock 121 (which is the reference time when the third cycle is timed and is the reference time when the application data is generated) to the measured quantity of electricity, thereby generating the application data.

The transmitter 123 transmits, in each third cycle, the application data generated by the application 122 to the network 102 at a random timing within the third cycle. Specifically, the transmitter 123 transmits, when the random timer times the random time, an application frame of the application data generated by the application 122 to the network 102.

The communication unit 124 communicates with the slave device 110 via the network 102 in each second cycle. Specifically, the communication unit 124 communicates a synchronization frame of synchronization data for time synchronization to the slave device 110 via the network 102 in each second cycle.

For example, the communication unit 124 receives, in each second cycle, the first synchronization frame including the time stamp t1 from the slave device 110 via the network 102 and defines, as the time stamp t2, a time stamp showing the reference time timed by the clock 121 upon reception of the first synchronization frame.

The communication unit 124 then defines, as the time stamp t3, a time stamp oh wing the reference time timed by the clock 121 upon transmission of the second synchronization frame and transmits the second synchronization frame including the time stamps t2 and t3 to the slave device 110 via the network 102.

FIG. 4 is a flowchart illustrating an exemplary procedure flow of processing for generating the application data performed in the slave device 110 according to the first embodiment.

The application 112 stands by until the first cycle timer times (measures) the first cycle (No in step S101).

The application 112 measures quantity of electricity when the first cycle timer times the first cycle (Yes in step S101), adds (stamps) the time stamp to showing the local time timed by the clock 111 to the measured quantity of electricity, thereby generating the application data (step S203). Thereafter, the flow returns to step S101.

Note that processing for generating the application data in the master device 120 is also performed by a similar procedure to that in FIG. 4. In this case, the application 112 should be read as the application 122, the first cycle as the third cycle, the clock 111 as the clock 121, the local time as the reference time, and the time stamp tα as the time stamp tβ.

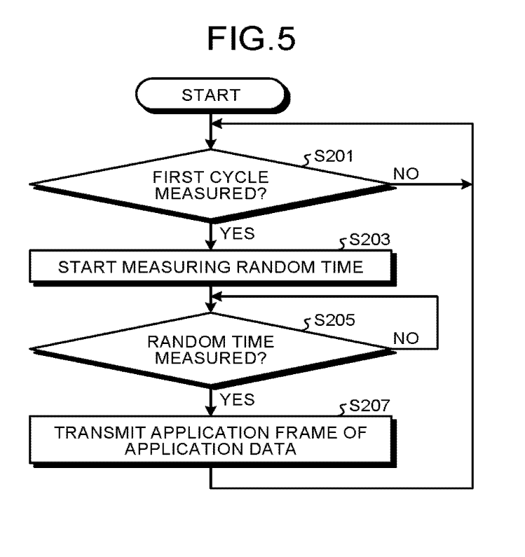

FIG. 5 is a flowchart illustrating an exemplary procedure flow of processing for transmitting the application data performed in the slave device 110 according to the first embodiment.

The random timer stand by until the first cycle timer times (measures) the first cycle (No in step S201) and, when the first cycle timer times the first cycle (Yes in step S201), starts timing the random time (step S203).

Thereafter, the transmitter 113 stands by until the random timer times the random time (No in step S205) and, when the random timer times the random time (Yes in step S205), transmits an application frame of the application data generated by the application 112 to the network 102 (step S207).

Note that processing for transmitting the application data in the master device 120 is also performed by a similar procedure to that in FIG. 5. In this case, the first cycle should be read as the third cycle, the transmitter 113 as the transmitter 123, and the application 112 as the application 122.

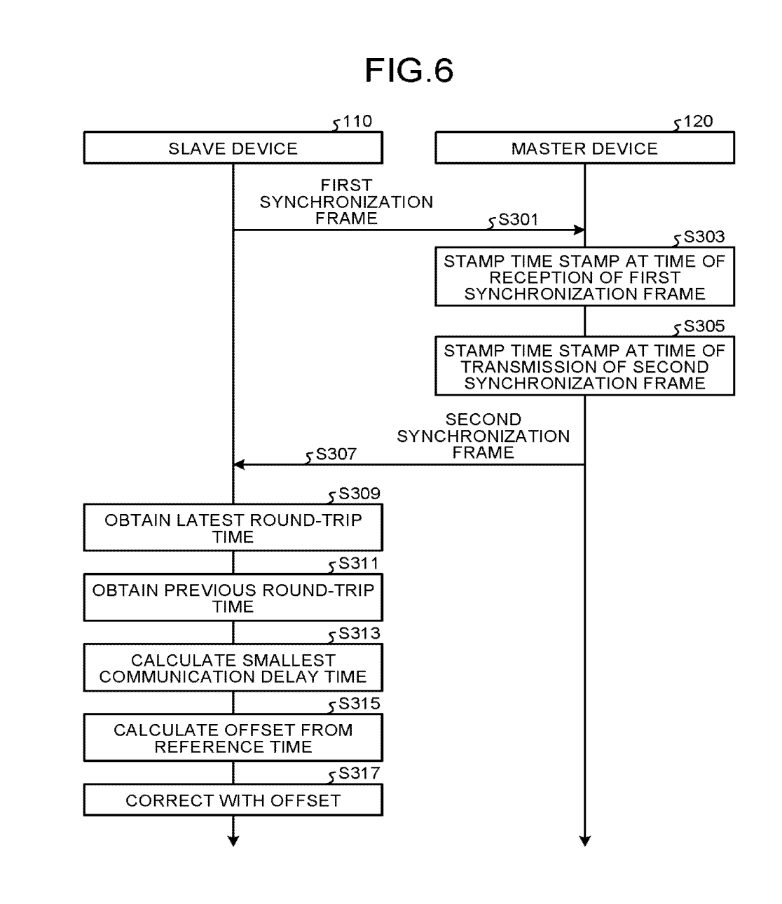

FIG. 6 is a sequence diagram illustrating an exemplary procedure flow of synchronization processing performed in the communication system 101 according to the first embodiment.

First, the communication unit 114 of the slave device 110 transmits, when the second cycle timer times the second cycle, the first synchronization frame including the time stamp t1 showing the local time timed by the clock 111 to the master device 120 via the network 102 (step S301).

The communication unit 124 of the master device 120 then receives the first synchronization frame from the slave device 110 via the network 102 and stamps, on the second synchronization frame, the time stamp t2 showing the reference time timed by the clock 121 upon reception of the first synchronization frame (step S303).

The communication unit 124 then stamps, on the second synchronization frame, the time stamp t3 showing the reference time timed by the clock 121 upon transmission of the second synchronization frame (step S305) and transmits the second synchronization frame including the time stamps t2 and t3 to the slave device 110 via the network 102 (step S307).

Thereafter, the communication unit 114 receives the second synchronization frame from the master device 120 via the network 102. The estimator 116 of the slave device 110 obtains, as the latest round-trip communication time, the latest set of the time stamps t1 to t4 from the communication unit 114 (step S309).

The estimator 116 then obtains, as the previous round-trip communication times, one or more previous sets of time stamps t1 to t4 from the storage 115 (step S311).

The estimator 116 then calculates (estimates) the smallest communication delay time with Formula (1) (step S313).

The synchronizer 117 then calculates the offset between the reference time timed by the master device 120 and the local time timed by the clock 111 with Formula (2) (step S315) and causes the clock 111 to correct, using the calculated offset, the local time to be timed (step S317).

As described above, since a transmission timing of the application frame is randomized in the first cycle and third cycle according to the first embodiment, it is expected that a timing is achieved where burstiness and periodicity of traffic (specifically, traffic such as that of application frames excluding that of synchronization frames) in the network 102 are mitigated.

When the slave device 110 and the master device 120 perform time synchronization through communication of the synchronization frame in such a timing, a periodical conflict of the application frame and the synchronization frame is unlikely to occur on the network 102 and thus periodical fluctuation of queuing time is unlikely to occur in communication of the synchronization frame. Therefore, it is expected that short outward communication time and return communication time can be obtained from multiple times of communication of the synchronization frame.

Furthermore, not only the latest outward communication time and return communication time but also previous outward communication times and return communication times are used for estimation of the communication delay time according to the first embodiment. Therefore, once the short outward communication time and return communication time optimum for correct estimation of the communication delay time is obtained, the communication delay time is estimated using these short outward communication time and return communication time thereafter.

Therefore, an estimation accuracy of the communication delay time can be expected to be improved as time elapses according to the first embodiment. An accuracy of time synchronization can also be expected to be improved since the communication delay time of such high estimation accuracy is used for performing time synchronization.

That is, according to the first embodiment, time synchronization can be performed while influence of communication conflict (influence of burstiness and periodicity) in the network 102 is avoided and thus the accuracy of time synchronization can be expected to be improved while cyclic communication of the application data can be ensured.

### Second Embodiment

In a second embodiment, an example is described where a communication system includes a communication device other than a slave device and a master device. The communication device also transmit application data at a random timing within a cycle. Hereinafter, different points from the first embodiment are mainly described. Elements having a similar function to those of the first embodiment are denoted with similar name and sign to those of the first embodiment and descriptions thereon are omitted.

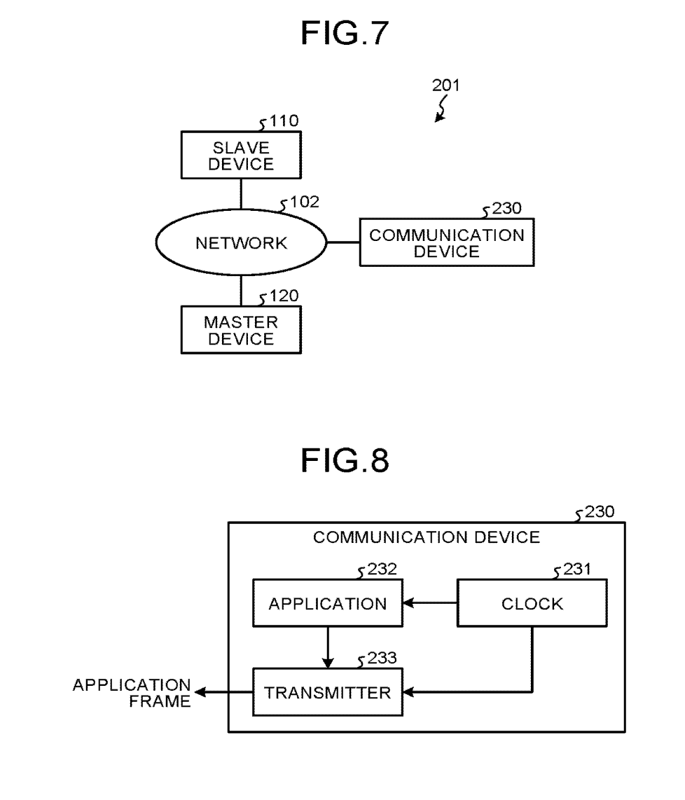

FIG. 7 is a diagram illustrating an exemplary configuration of a communication system 201 according to the second embodiment. A different point from the first embodiment is that a communication device 230 (an example of a third communication device) is connected to a network 102.

FIG. 8 is a diagram illustrating an exemplary configuration of the communication device 230 according to the second embodiment. As illustrated in FIG. 8, the communication device 230 includes a clock 231, an application 232 (an example of a third application), and a transmitter 233 (an example of a third transmitter).

The clock 231, application 232, and transmitter 233 may be implemented by execution of a program by a processor such as a CPU, namely, by software, by hardware such as an IC, or by combination of software and hardware.

The clock 231 times local time which is time within the communication device 230. Here, the clock 231 also functions, while the local time that the clock 231 times, as a fourth cycle timer for timing a fourth cycle and a random timer for timing random time within the fourth cycle.

The fourth cycle is a transmission cycle of application data (an example of third application data) generated by the application 232. In the second embodiment, the fourth cycle is defined as the same cycle as the first cycle and the third cycle but may be a different cycle.

The random time is time shorter than the fourth cycle and is determined, for example, by the clock 231 with a random value or the like. Therefore, it is expected that the random time is different in each fourth cycle. The random timer starts timing the random time when the fourth cycle timer times the fourth cycle and times the random time within the fourth cycle.

The application 232 generates the application data each time the fourth cycle timer times the fourth cycle.

The second embodiment is described with an example where the application 232 is an application that measures quantity of electricity; however, the application 232 is not limited thereto. In this case, the application 232 measures quantity of electricity in each fourth cycle, adds (stamps) a time stamp tγ showing the local time timed by the clock 231 (which is the local time when the fourth cycle is timed as well as the local time when the application data is generated) to the measured quantity of electricity, thereby generating the application data.

The transmitter 233 transmits, in each fourth cycle, the application data generated by the application 232 to the network 102 at a random timing within the fourth cycle. Specifically, the transmitter 233 transmits, when the random timer times the random time, an application frame of the application data generated by the application 232 to the network 102.

Note that processing for generating the application data in the communication device 230 is also performed by a similar procedure to that in FIG. 4. In this case, the application 112 should be read as the application 232, the first cycle as the fourth cycle, the clock 111 as the clock 231, and the time stamp to as the time stamp tγ.

Similarly, processing for transmitting the application data in the communication device 230 is also performed by a similar procedure to that in FIG. 5. In this case, the first cycle should be read as the fourth cycle, the transmitter 113 as the transmitter 233, and the application 112 as the application 232.

As described above, since a transmission timing of the application frame is randomized in the first cycle, third cycle, and fourth cycle according to the second embodiment, it is expected that a timing is further achieved where burstiness and periodicity of traffic (specifically, traffic such as that of application frames excluding that of synchronization frames) in the network 102 are mitigated.

### Third Embodiment

In a third embodiment, an example is described where a communication system includes a communication device other than a slave device and a master device and the communication device transmits application data at a random timing within a cycle by using a transfer device. Hereinafter, different points from the second embodiment are mainly described. Elements having a similar function to those of the second embodiment are denoted with similar name and sign to those of the second embodiment and descriptions thereon are omitted.

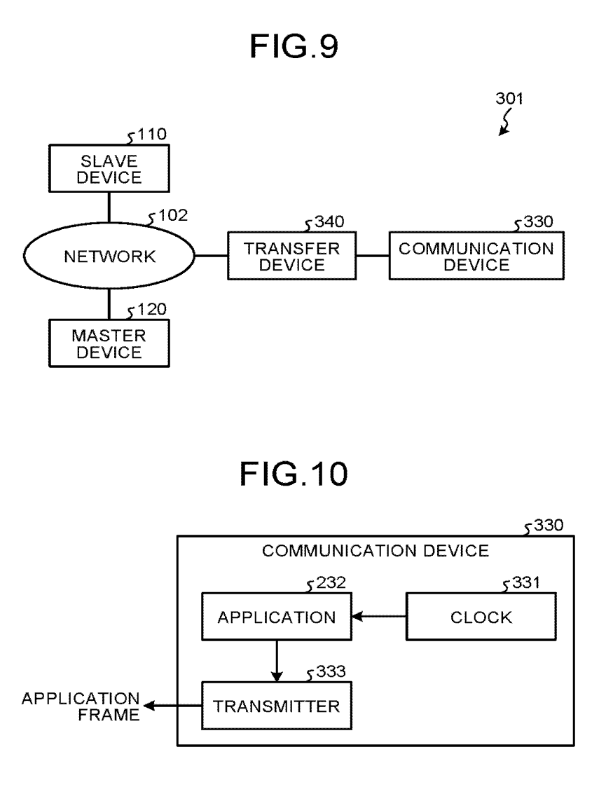

FIG. 9 is a diagram illustrating an exemplary configuration of a communication system 301 according to the third embodiment. Different points from the second embodiment are that a transfer device 340 is connected to a network 102 and that a communication device 330 is connected to the transfer device 340. The transfer device 340 may be a device directly connected to the communication device 330 such as a network card of the communication device 330 or a universal serial bus (USB) type converter but not limited thereto. The transfer device 340 may be a device connected the communication device 330 via the network 102.

FIG. 10 is a diagram illustrating an exemplary configuration of the communication device 330 according to the third embodiment. As illustrated in FIG. 10, the communication device 330 includes a clock 331 and a transmitter 333, which are different from those of the second embodiment.

In the third embodiment, the clock 331 does not function as a random timer.

The transmitter 333, upon generation of application data by an application 232, transmits the application data to the transfer device 340.

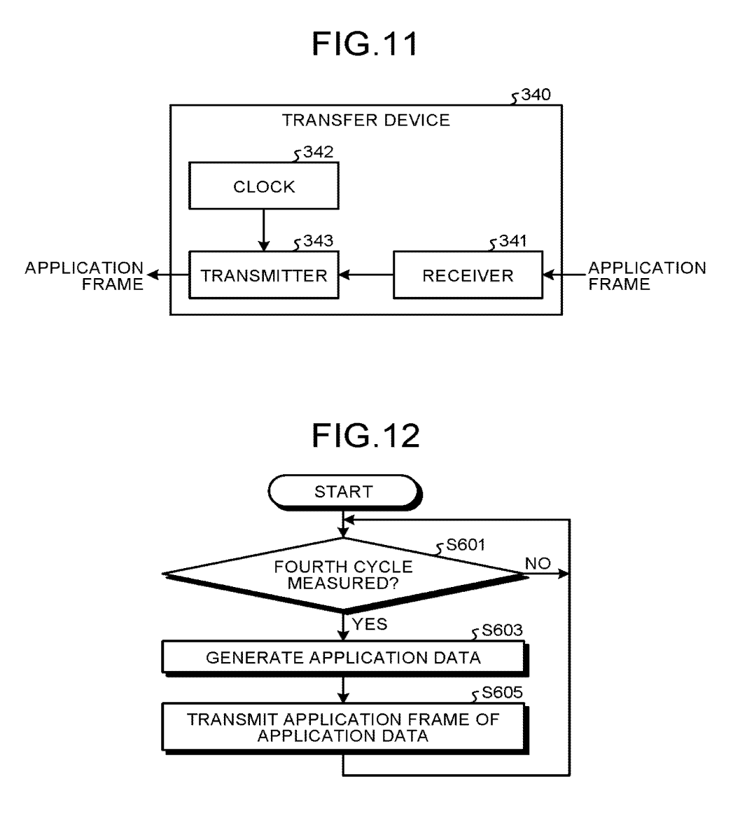

FIG. 11 is a diagram illustrating an exemplary configuration of the transfer device 340 according to the third embodiment. As illustrated in FIG. 11, the transfer device 340 includes a receiver 341, a clock 342, and a transmitter 343 (an example of a fourth transmitter).

The receiver 341, clock 342, and transmitter 343 may be implemented by execution of a program by a processor such as a CPU, namely, by software, by hardware such as an IC, or by combination of software and hardware.

The receiver 341 receives the application data from the communication device 330.

The clock 342 times local time which is time within the transfer device 340. Here, the clock 342 also functions, while using the local time that the clock 342 times, as a fourth cycle timer for timing a fourth cycle and a random timer for timing random time within the fourth cycle.

Note that the fourth cycle timer is synchronized with a fourth cycle timer of the clock 331 in the communication device 330. That is, the fourth cycle timer of the clock 331 and the fourth cycle timer of the clock 342 time the fourth cycle at the same timing.

The random time is time shorter than the fourth cycle. Specifically, the random time is time shorter than time from reception of the application data by the receiver 341 to completion of the fourth cycle and is determined, for example, by the clock 342 with a random value or the like. Therefore, it is expected that the random time is different in each fourth cycle. The random timer starts timing the random time upon reception of the application data by the receiver 341 and times the random time within the fourth cycle.

The transmitter 343 transmits, in each fourth cycle, the application data received by the receiver 341 to the network 102 at a random timing within the fourth cycle and after reception of the application data by the receiver 341. Specifically, the transmitter 343 transmits, when the random timer times the random time, an application frame of the application data received by the receiver 341 to the network 102.

FIG. 12 is a flowchart illustrating an exemplary procedure flow of processing performed in the communication device 330 according to the third embodiment.

The application 32 stands by until the fourth cycle timer times (measures) the fourth cycle (No in step S601).

The application 232 then measures quantity of electricity when the fourth cycle timer times the fourth cycle (Yes in step S601), adds (stamps) a time stamp tγ showing the local time timed by the clock 331 to the measured quantity of electricity, the by generating the application data (step S603).

Thereafter, the transmitter 333 transmits the application frame of the application data generated by the application 232 to the transfer device 340 (step S605).

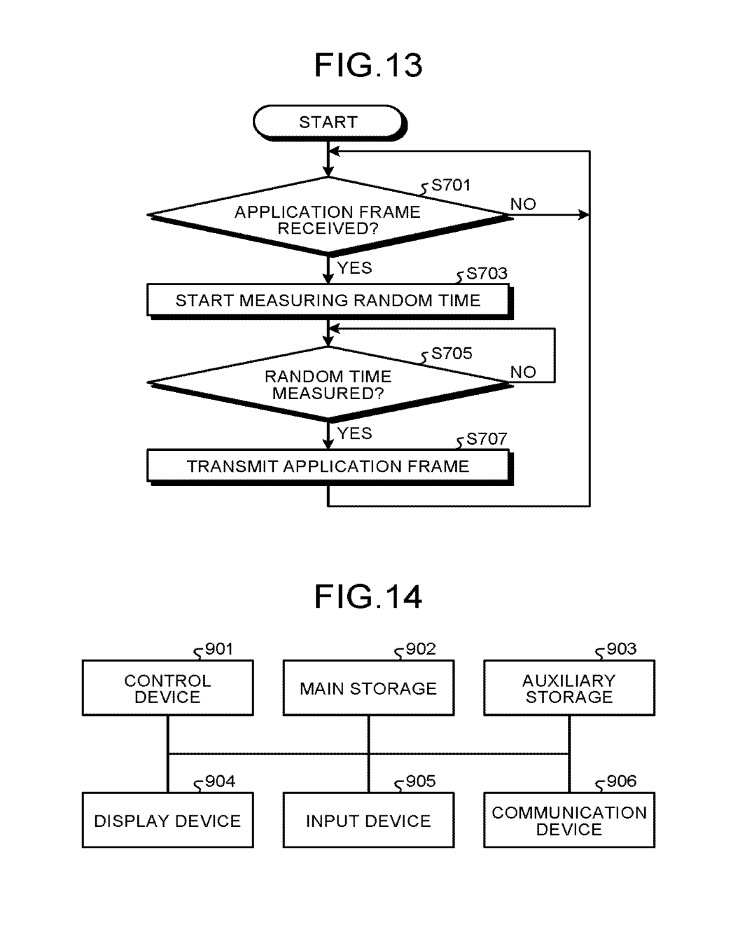

FIG. 13 is a flowchart illustrating an exemplary procedure flow of processing performed in the transfer device 340 according to the third embodiment.

The receiver 341 stands by until the application frame is received from the communication device 330 (No in step S701). When the receiver 341 receives the application frame (Yes is step S701), the random timer starts timing the random time (step S703).

Thereafter, the transmitter 343 stands by until the random timer times the random time (No in step S705) and, when the random timer times the random time (Yes in step S705), transmits the application frame received by the receiver 341 to the network 102 (step S707).

As described above, since a transmission timing of the application frame can be randomized by the transfer device according to the third embodiment even when the communication device is not capable of randomizing the transmission timing of the application frame, it is expected that a timing is further achieved where burstiness and periodicity of traffic (specifically, traffic such as that of application frames excluding that of synchronization frames) in the network 102 are mitigated.

### Hardware Configuration

FIG. 14 is a diagram illustrating an exemplary hardware configuration of the slave device, master device, communication device, and transfer device of the respective embodiments (hereinafter referred to as the respective device, of the respective embodiments). As illustrated in FIG. 14, the respective devices of the respective embodiments include a control device 901 such as a CPU, a main storage 902 such as a ROM or RAM, an auxiliary storage 903 such as an HDD or SSD, a display device 904 such as a display, an input device 905 such as a keyboard or a mouse, and a communication device 906 such as a communication interface and thus have a hardware configuration using a normal computer.

The program executed on the respective devices of the respective embodiments is provided by being stored in a computer-readable storage medium, which may be provided as a computer program product, such as a CD-ROM, CD-R, memory card, digital versatile disk (DVD), or flexible disk (FD) in a file with a format installable or executable.

Alternatively, the program executed on the respective devices of the respective embodiments may be provided by being stored in a computer connected to a network such as the Internet and allowing download therefrom via the network. Alternatively, the program executed on the respective devices of the respective embodiments may be provided or distributed via a network such as the Internet. Further alternatively, the program executed on the respective devices of the respective embodiment may be provided by incorporation in a ROM or the like in advance.

The program executed on the respective devices of the respective embodiment has a modular configuration for implementing the aforementioned respective units on a computer. In actual hardware, a CPU reads the program from a ROM or HDD to a RAM and executes the program, thereby implementing the aforementioned respective units on a computer. Note that, when implementing at least one portion of the aforementioned respective units by hardware such as an IC or the like, the respective devices of the respective embodiments are only required to further include the IC or the like.

The present invention is not limited to the aforementioned respective embodiments as they are but may be implemented with modifications to the elements without departing from the principals of the present invention in an implementation phase. Furthermore, by appropriately combining the plurality of elements disclosed in the aforementioned respective embodiments, various inventions may be formed. For example, some elements may be disregarded from among all the elements illustrated in the embodiment. Furthermore, the elements from different embodiments may be combined as appropriate.

For example, the respective steps in the flowcharts of the respective embodiments may be, unless contrary to the nature thereof, executed in a different order or executed in a different order every execution. Some of the respective steps in the flowcharts of the respective embodiments may be executed simultaneously.

As described above, according to the respective embodiments, influence of communication conflict in a network can be avoided while cyclic data communication can be ensured.

While certain embodiments have been described, embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
an application configured to generate application data in each first cycle;
a transmitter configured to transmit the application data to a network at a random timing within the first cycle in each first cycle;
a communication unit configured to communicate with another communication device via the network in each second cycle; and
an estimator configured to
calculate an outward communication time and a return communication time of communication between the communication device and the other communication device in each second cycle, and
estimate a communication delay time between the communication device and the other communication device based on the calculated outward communication times and the calculated return communication times.

2. The device according to claim 1, wherein the estimator extracts a smallest outward communication time and a smallest return communication time from among the outward communication times and the return communication times, and estimates the communication delay time to he a half of a round-trip communication time that is a sum of the smallest outward communication time and the smallest return communication time.

3. The device according to claim 1, wherein
the other communication device is a master device that is a time synchronization source,
the communication unit communicates synchronization data for time synchronization with the other communication device,
the synchronization data transmitted from the other communication device includes a first time stamp indicating reference time timed by the other communication device,
the device further comprises a synchronizer configured to perform time synchronization based on the communication delay time and the first time stamp included in the synchronization data having the smallest return communication time.

4. The device according to claim 3, further comprising clock configured to time local time,
wherein the synchronizer calculates an offset between the local time when the synchronization data is received and the reference time, using the communication delay time, the first time stamp included in the synchronization data having the smallest return communication time, and the local time, and causes the clock to correct the local time to be timed with the calculated offset.

5. The device according to claim 1, wherein
the application measures quantity of electricity, and
the application data includes a second time stamp indicating the local time when the application data is generated, and the measured quantity of electricity.

6. A communication system comprising a first communication device and a second communication device, wherein
the first communication device includes
a first application configured to generate first application data in each first cycle;
a first transmitter configured to transmit the first application data to a network at a random timing within the first cycle in each first cycle;
a first communication unit configured to communicate with the second communication device via the network in each second cycle; and
an estimator configured to
calculate an outward communication time and a return communication time of communication between the first communication device and the second communication device in each second cycle, and
estimate a communication delay time between the first communication device and the second communication device based on the calculated outward communication times and the calculated return communication times, and
the second communication device includes a second communication unit configured to communicate with the first communication device via the network in each second cycle.

7. The system according to claim 6, wherein
the second communication device further includes
a second application configured to generate second application data in each third cycle; and
a second transmitter configured to transmit the second application data to the network at a random timing within the third cycle in each third cycle.

8. The system according to claim 6, further comprising a third communication device, wherein
the third communication device includes
a third application configured to generate third application data in each fourth cycle; and
a third transmitter configured to transmit the third application data to the network at a random timing within the fourth cycle in each fourth cycle.

9. The system according to claim 6, further comprising a third communication device and a transfer device, wherein
the third communication device includes
a third application configured to generate third application data in each fourth cycle; and
a third transmitter configured to transmit the third application data to the transfer device, and
the transfer device includes
a receiver configured to receive the third application data from the third communication device; and
a fourth transmitter configured to transmit the third application data to the network at a random timing within the fourth cycle and after reception of the third application data in each fourth cycle.

10. A computer program product comprising a computer-readable medium containing a program executed by a computer of a communication device, the program causing the computer to execute:
generating application data in each first cycle;
transmitting the application data to a network at a random timing within the first cycle in each first cycle;
communicating with another communication device via the network in each second cycle;
calculating an outward communication time and a return communication time of communication between the communication device and the other communication device in each second cycle; and
estimating a communication delay time between the communication device and the other communication device based on the calculated outward communication times and the calculated return communication times.
